(19) United States
(12) Patent Application Publication
(10) Pub. No.: US 2020/0071985 A1
(43) Pub. Date: Mar. 5, 2020

(54) Laboratory Specimen Box System

(71) Applicant: Kathleen Winter, Lodi, CA (US)

(72) Inventor: Kathleen Winter, Lodi, CA (US)

(21) Appl. No.: 16/558,232

(22) Filed: Sep. 2, 2019

Related U.S. Application Data
(60) Provisional application No. 62/726,188, filed on Aug. 31, 2018.

(51) Int. Cl. E05G 1/10; H04Q 9/00; G06Q 10/08; E05G 1/00; E05G 1/024

(52) U.S. Cl. CPC E05G 1/10; H04Q 9/00; G06Q 10/0832; G06Q 10/08355; G01S 19/13; E05G 1/024; H04Q 2209/883; H04Q 2209/40; E05G 1/005

(57) ABSTRACT

This document describes a system and method for detecting and reporting the presence of contents within a laboratory specimen lockbox. The detection of environmental conditions (temperature, moisture/humidity or location, for example) is further disclosed. The information obtained by the sensors can be used to provide timely courier service to lockboxes containing specimens (particularly where environmental conditions threaten specimen viability) and can be used to avoid sending couriers to empty lockboxes.

### CROSS REFERENCE TO RELATED APPLICATIONS

The present application claims the benefit of provisional patent application Ser. No. 62/726,188, filed Aug. 31, 2018, by the present inventor. The provisional application is incorporated by reference in its entirety.

### FIELD OF THE INVENTION

The present invention relates to laboratory specimen boxes. In particular, the present invention relates to specimen boxes that can reduce unnecessary specimen transportation costs.

### BACKGROUND OF THE INVENTION

The medical courier industry provides logistics services for laboratories, hospitals, ambulatory service centers (ASC) and other related medical operations in the pickup, transportation and delivery of medical specimens from medical providers to laboratories. These logistics services are typically provided by employees of the organizations (laboratories, hospitals or ASC), third party companies, or both as demand fluctuates and often requires courier training in the safe handling and transport of specimens to protect specimen integrity and to avoid hazardous exposures. This can lead to a non-trivial expense in operating a courier service. Further, the cost of these courier services continue to increase due to employee wages, benefits and related transportation expenses. More broadly, the healthcare service industry continues to experience declines in reimbursement for laboratory services and the impact of increasing courier costs to the profitability of laboratories is an ongoing challenge.

In an effort to balance the expense of using couriers, the convenience of on-site lockboxes and the urgency of specimen collection, laboratories and hospital couriers can operate with several schedules for pickup. The first and most common schedule for laboratories is a scheduled pick up. The courier checks the laboratory specimen lockbox on a specific schedule, e.g. certain day(s) of the week, and after a certain time of the day. These metal specimen lockboxes can be inside a medical practice office, in a specified location and/or located outside of the building for pickups after business hours. Couriers then make a stop to check the contents of the box. Approximately 20-25% of the time the specimen box is empty. In such cases, the laboratory has incurred the cost of the scheduled pickup, with no ensuing services to generate laboratory revenue.

Other efforts to address this problem have involved requiring personnel at the pickup location to take some action once the specimen has been deposited in the lockbox in order to notify the courier service that a specimen awaits transport. In practice, no matter how simple or complex the additional step may be, office staff are often reluctant or unable to reliably perform any additional tasks. And so, cumulatively, these efforts have failed to effectively address the problem.

Other efforts in this general space have involved providing specialized sophisticated hardware for receiving and transporting specimens. For example, Chinese reference CN206400322U shows a specimen transportation lockbox that is instrumented with lights, a speaker, sensors and communication. United States reference US20140032034A1 discusses an aerial vehicle that for transporting a variety of payloads. These fairly expensive solutions are both directed to the problem of transporting items and do little to address the question of whether an item actually requires transportation.

What is needed is an inexpensive and convenient way to make more efficient use of couriers.

### SUMMARY OF THE INVENTION

The present invention is a laboratory specimen lockbox system that can sense the deposit of a specimen within a lockbox and then automatically send a signal to designated couriers, thereby reducing the deployment of couriers to empty lockboxes. The proposed solution starts with a laboratory specimen lockbox and enhances it with a (preferably all-in-one) module to sense the presence of a specimen and communicate the presence of the specimen so that an appropriate courier route can be developed. Additional sensors may be provided to monitor environmental conditions in the box, for example, to facilitate courier routing and to alert personnel of conditions that may affect specimen viability before courier pickup. The present invention does not necessarily require any additional action on the part of those responsible for sending the specimen and could be deployed inexpensively.

A further advantage of improving courier efficiency in collecting specimens is that the specimens would be collected sooner, thus reducing the time in which samples could degrade or be at risk of contamination. Typically, the sooner a sample can be collected and processed, the more reliable the results.

Improving courier efficiency in collecting specimens would also decrease turnaround time for the delivery of results. A combination of more reliable results and a short turnaround time would result in repeat business for the laboratory.

### BRIEF DESCRIPTION OF THE DRAWINGS

FIG. 1 is a perspective view of a laboratory specimen box system and specimen in accordance with an embodiment of the present invention;

FIG. 2 is a perspective view of an enclosure with a pressure sensor suitable for mounting within a specimen box;

FIG. 3 is a schematic view of components of an embodiment of an enclosure;

FIG. 4 shows a schematic view of a laboratory specimen box containing a camera sensor;

FIG. 5 shows a schematic view of a laboratory specimen box containing an audio sensor;

FIG. 6 shows a schematic view of a laboratory specimen box with a top-mounted solar panel;

FIG. 7 shows a perspective view of an enclosure; and

FIG. 8 shows an exploded view of an enclosure with a mechanical limit switch.

### DESCRIPTION OF PREFERRED EMBODIMENTS

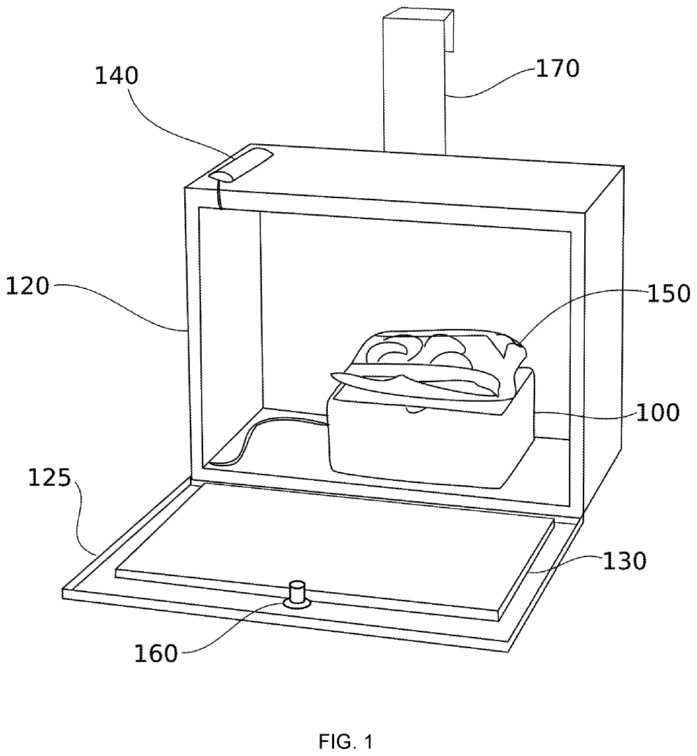

The present invention can be assembled from a variety of commercially available components and standard industrial hardware in a custom-designed enclosure (or housing) 100 that will be placed inside the medical specimen collection box 120 (also called a “specimen box” or “lockbox”). FIG. 1 shows an embodiment of the invention. A lab specimen box 120 is shown with a hook 170 for mounting on a door as is common in the industry. The specimen box 120 may be lockable, for example with a lock 160 on a hinged door 125. The door 125 and interior surface may be partially or fully covered with an insulative layer 130. An enclosure 100 is provided within the specimen box 120 providing a sensor or sensors to detect the presence of a specimen 150 or other package. An associated communications module 330, preferably located within the enclosure 100, functions to transmit a message indicating the status of the specimen box 120 (“contains specimen,” for example, or “empty”). An antenna 140 may be mounted on the box 120 to provide additional range for the communication.

### Detecting a Specimen

Detecting the presence of a specimen can be achieved in a variety of ways including, for example, by sensing the mass of the specimen, its optical characteristics or a change in the acoustic properties of the interior of the box.

In the simplest example, the deposit of a specimen can be detected by a switch connected to the lockbox door 125 acting as a sensor. If the lockbox door opens and then closes (in the absence of a courier), it can be assumed that a deposit has been made. While such an embodiment would be simple and inexpensive, it comes with a risk of false positives, such as instances of opening and closing the door without depositing a specimen. Nonetheless, a system that simply monitored whether a door was opened would be an improvement over traditional specimen lockboxes in some circumstances.

In a preferred embodiment, the deposit of a specimen may be detected by providing a pressure sensitive surface 200 on the bottom of the lockbox. When a specimen is placed on the pressure sensitive surface 200, a change is registered resulting in the transmission of a signal indicating the deposit of a specimen. One option for registering a change in pressure/weight is via a mechanical limit switch 820. As an alternative, one could use a solid-state strain gauge or other pressure sensor, as desired (depending on sensitivity, durability and cost considerations). The end result being that the mass or weight of the deposited specimen is detected and a signal is sent (either immediately or based on a customized notification schedule) indicating the change.

Embodiments of the invention may take several forms, depending on the specific application. In embodiments using pressure sensitive surfaces, it may be beneficial to have the sensing surface extend over the entire interior surface of the specimen lockbox to ensure that a specimen may be detected no matter where it is placed (within the specimen lockbox). This may take the form of a false floor, hiding the enclosure, sensor and most of the functional components. In contrast, the embodiment shown in FIG. 1 depicts an enclosure without a false floor for simplicity.

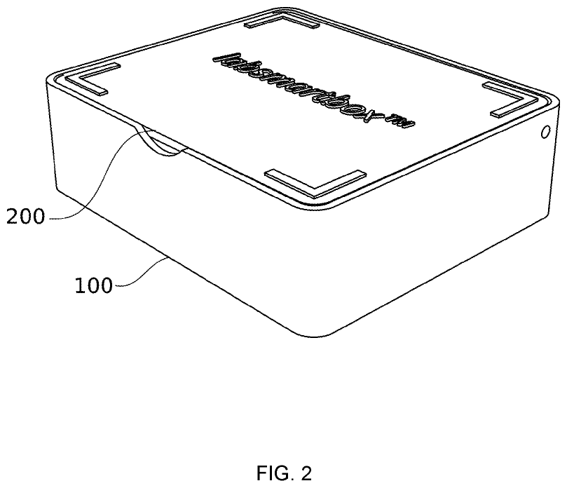

FIG. 2 shows a view of an enclosure 100 in one embodiment of the invention. In this embodiment, a pressure plate 200 covers internal components and transmits the mass of a specimen 150 to a sensor 310 for detection.

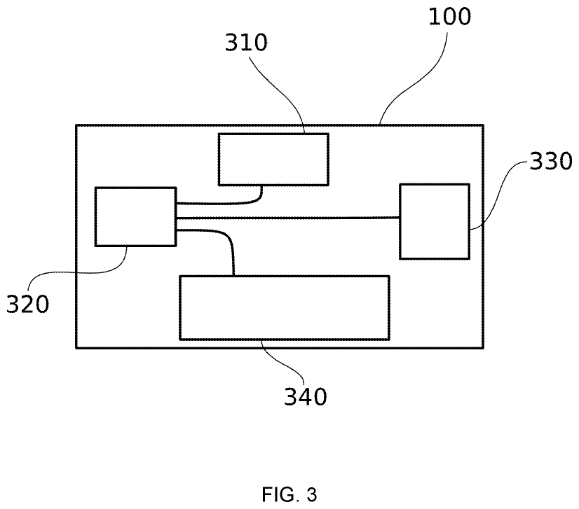

FIG. 3 shows components of an embodiment of the invention that may not be visible from the exterior of the enclosure. In this example, a processor or microcontroller 320 is powered by a battery or power supply 340. The processor 320 receives readings or measurements from one or more sensors 310 and communicates state information to a remote location via a communications module 330. In the simple use example provided above, at least one of the sensors 310 is used to determine that a specimen 150 has been deposited by detecting the mass of the specimen 150 on a pressure sensitive surface 200.

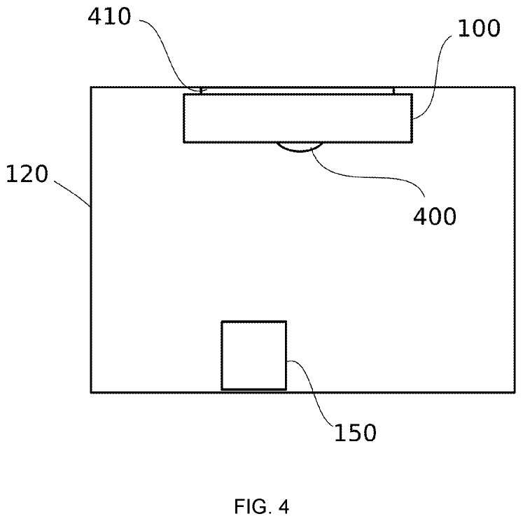

In other embodiments, the deposit of a specimen 150 might be detected by a camera 400 within the lockbox 120, as is shown in FIG. 4. With a camera 400 positioned to see at least a portion of the interior of the lockbox (the bottom interior surface, for example), rudimentary image processing and comparison could be used to note differences between the visual characteristics of the interior of the lockbox 120 when a specimen 150 is present and the characteristics when the lockbox is empty. The images can be sampled continuously or at intervals and additional lighting (low energy LEDs, for example) may be provided to normalize the illumination within the box and prevent the time of day from impacting the accuracy of detection.

In another embodiment, one or more light sources and one or more light sensors could be arranged within the lockbox 100 such that the deposit of a sample would interrupt the transmission of light from the light source to the sensor.

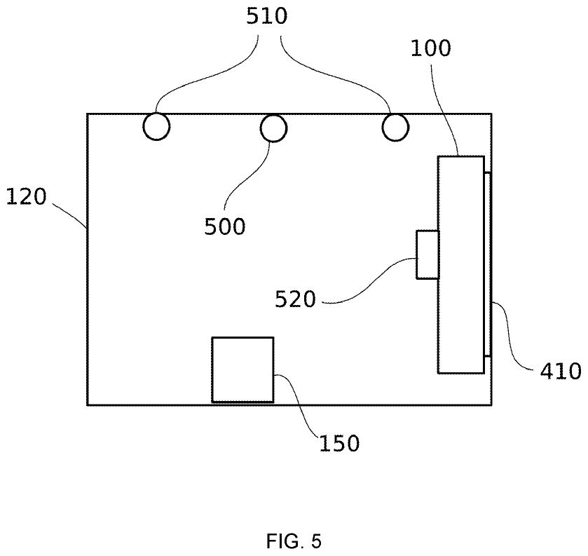

In yet another embodiment, sound waves could be produced by an emitter/speaker 500 and received by one or more receivers/microphones 510, as shown in FIG. 5. The speaker 500 and microphones 510 in this example are in wireless communication with the components within the enclosure 100, enabling sound generation and measurement to be facilitated by a processor 320. Careful comparison of the signals emitted and recorded in empty lockboxes and those containing specimens could suggest the presence or absence of a specimen 150. Radio waves could be used for a similar purpose. Any waves used for this purpose would need to be weak enough to avoid disturbing the specimen to be collected but strong enough to be detected by a receiver/microphone.

As can be seen, specimen presence may be detected at the box using a variety of techniques and sensors of varying complexity (alone or in combination) in accordance with the teachings of this invention.

### Detecting Environmental Conditions

In addition to detecting the presence of a specimen, the lockbox 120 might also be equipped with additional (secondary) sensors to detect environmental conditions or the state of the specimen. FIG. 5 shows an example of such a secondary sensor 520 for measuring temperature. Small and energy efficient sensors are available to detect a broad range of conditions, including temperature, humidity and geographic position. Such sensors 310 may be activated periodically or in response to specimen detection by the primary sensor.

In some embodiments, the lockbox 120 could be equipped with a sensor or sensors to monitor the temperature conditions a specimen inside the box is being or has been exposed to. One way to monitor temperatures inside the lockbox 120 would be to equip it with a thermometer. Such a sensor 520 could be used to indicate current conditions inside the box. Alternatively, a thermometer activated by the detection of a specimen inside the box could take readings at intervals and transmit a series of readings allowing a courier/lab to know if the specimen 150 has been exposed to extreme temperatures while awaiting collection. This information would be important because many samples may not tolerate prolonged exposure to extreme temperatures. If a courier was alerted to the presence and location of specimens in urgent need of collection, the increased efficiency would mean that more viable specimens would arrive at the laboratory, reducing the need for repeat collections. An alternate embodiment might include a thermosensitive material that could indicate whether past temperatures had risen past a certain point. For example, tape that changes color after exposure to a specific temperature could be added to the box 120.

Some embodiments may be equipped with sensors that monitor other environmental conditions that could affect sample viability (such as humidity). This information may also be transmitted to a courier. It is especially useful to activate sensing of the desired parameter in response to specimen detection.

Other embodiments might measure how much time has elapsed since a specimen was placed in the box and transmit that information to a courier. Such information could be important to couriers and labs because many samples can degrade over time. Embodiments combining mechanisms for measuring environmental conditions and the time elapsed after the placement of a specimen in the box may be especially advantageous in this context.

Some embodiments may include Global Positioning System (GPS) receivers as sensors. A GPS sensor could be activated to transmit GPS coordinates in response to the detection of a specimen in the box. This information facilitates the generation of efficient routes for collecting available specimens.

Environmental conditions may also be estimated by employing so-called virtual sensors. According to available records of regional environmental conditions, the specific conditions of the specimen box can be calculated. This mechanism is easy to implement and frequently used in the context of automated irrigation.

### Transmitting a Signal

Once the sensors have detected the deposit of a specimen 150, there are many ways available to send a signal to the courier service. Cellular networks and IEEE standard 802.11x (Wi-Fi or WiFi) stand out among desirable mechanisms supporting communication to courier services.

Depending on the application, each communication mechanism may have advantages and disadvantages.

In some embodiments, one or more cellular networks may be employed to enable communication of the specimen box state change signal. It may be advantageous to use cellular networks (including 4G, LTE and even slower technologies) in areas where the presence of an Ethernet network (wireless or otherwise) may not be available, may be unreliable or may be unacceptably troublesome to configure. In some cases, at a client site for example, it may not be appropriate to request network access. In some cases, “internet of things” (IoT) devices may be considered too high a security risk for private networks such as can be found at hospitals and physician offices. Cellular networks can be used in many of these circumstances to provide communication. Another advantage of cellular-type communication is that devices may be configured and tested at many locations—not necessarily limited to the area where the lockbox will be deployed. Because the necessary data volume for the system to operate is minimal, the cost of transmitting data over the cellular network can remain low. To further limit the flow of data and consumption of power, some embodiments may be configured to only activate the network interface periodically or when there is a change in the state of the lockbox.

In some embodiments, an ethernet or wireless network may be employed to provide signal communication. These types of deployments may be desirable in situations where the cellular coverage may be spotty and where there is an existing available network. In some cases, municipal WiFi networks provide free or low-cost Internet access over surprisingly large geographic areas. Some WiFi networks may be set up to support mesh configurations, enabling clients to chain together to extend the network's reach.

In some embodiments, a cellular network could be used to transmit temperature information, information about other environmental parameters, and/or GPS coordinates for the lockbox to the courier service as well as the presence of a sample. This preferably time-stamped information ultimately could provide sufficient detail for the route planner(s) to make more efficient use of available resources.

### Power Considerations

Because the sensors and communication mechanisms discussed above may be deployed in remote locations for long periods of time, it is advantageous to provide a power supply 340 that has a high capacity and that does not (often) require plugging in to an external supply. Even as the communication needs may be limited to times when the lockbox state has changed, the sensors must be online periodically or at least often enough to detect a change in the lockbox state. A number of electric battery technologies stand out as particularly well suited for use in this invention. Alternatively or in addition, the power supply 340 may provide for continuous or periodic charging by power source such as a plug-in AC adapter.

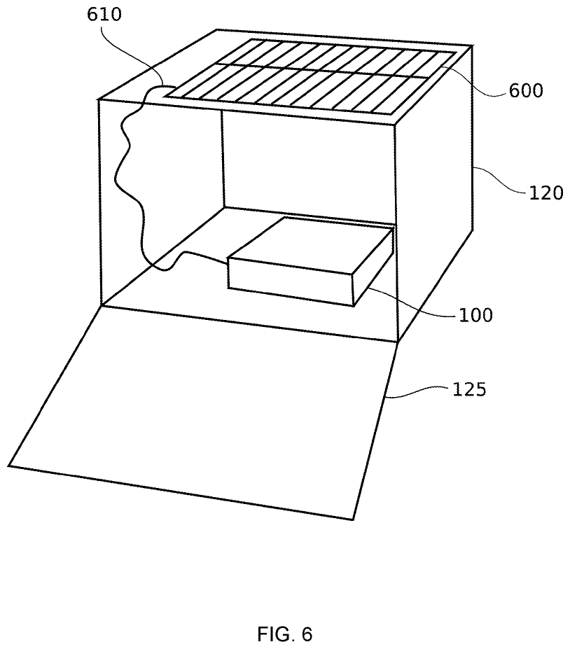

Rechargeable batteries, such as lithium-ion or lithium-polymer, may be ideal for an application such as this. Such batteries are available in many sizes and can be sourced quite inexpensively, especially if one selects a battery pack that has been developed for a popular device (such as a mobile phone). The idle discharge characteristics of many such batteries should enable a battery equipped lockbox to remain in a ready state for several unattended months, though this may depend on a number of environmental factors. Some embodiments may include small solar panels 600 for charging the batteries, particularly in applications where the lock boxes are deployed outdoors or in environments that receive sufficient light energy. Solar power is an efficient way to provide electricity due to the fact that it comes without a continued cost and is powered daily by the light energy transmitted to it. FIG. 6 shows a lab specimen box 120 with a solar panel 600 mounted on its top surface. An electrical connection 610 may be routed from the outside of the box 120 to the inside to transfer the power from the solar panel 600 to a battery within the enclosure 100. For applications where continuous monitoring is unnecessary, such a configuration may satisfy all of the energy requirements. Care must be taken in design, however, to ensure the resulting lockbox does not appear excessively valuable—so as to not attract attention as a theft target.

### Form Factor Considerations

A preferred embodiment of the present invention takes the form of an all-in-one module that can be placed neatly into a traditional specimen lockbox. One benefit of this form is that no reengineering is required of the actual lockbox. Existing lockboxes may easily be adapted into “smart” lockboxes simply by the addition of the inventive system. Beyond cost-savings, this modularity (where an additional hardware module is added to an existing lockbox) enables the desired functionality to be deployed in many kinds of specimen lockboxes. For example, insulated smart lockbox or an extra-secure smart lockbox may easily be constructed for applications where those characteristic is desired. Because the additional hardware may be fully contained within the lockbox 120, it is possible to equip a standard specimen lockbox with the entire system without making the lockbox any more likely to be tampered with or stolen, even in cases where design choices have resulted in more valuable componentry.

Where lockbox insulation is desired in a metal lockbox, for example, a foam or other insulating layer 130 may be applied to the inside or outside of the box and its lid. Similarly the box 120 may be environmentally sealed to help isolate the box contents 150, 100 from environmental factors (temperature and moisture changes, for example).

Depending on the technology selected for communication, there may be some advantage to mounting an antenna 140 on the exterior of the lockbox to decrease radio signal attenuation through the typically metal body of the lockbox. In such cases, it is recommended to orient such an antenna 140 close to the body of the specimen lockbox so as not to attract undue attention. For this reason, a flat or low profile antenna might be preferred. As an alternative, some embodiments may substitute at least one panel (the door, for example) of the lockbox with one made of a material (such as plastic) which will not attenuate the communication signal as much.

The provided renderings display various embodiments of the present invention as a module that can be placed within a specimen lockbox. The inventive system may take the form of a container that provides a false bottom surface (the weight sensor) and a false back surface (the door to the container for the power supply 340 and communications hardware 330) for a specimen lockbox 120. To ensure the specimen lockbox maintains as much of its original capacity as possible, it can be beneficial to avoid making the hardware of the present invention larger than is necessary to achieve the desired performance and other properties.

It should be clear that the provided examples show just a few of the many possible configurations/layouts of the hardware housing within the present inventive system. The present invention may be oriented in either a horizontal or vertical configuration based on the size of the medical specimen lockbox. One can easily imagine, as an alternative, a system (still using the example of a pressure-sensitive surface) where most or all of the hardware components are contained within a module located beneath the weight sensor surface 200, as shown in FIG. 2. In this example, the sensor surface or pressure plate 200 might be pivoted up or removed to provide access to internal components of the enclosure 100. It is noted that the required componentry may in fact be quite small. For perspective, a typical (and low-cost) modern mobile phone might contain more than sufficient communications 330 and power hardware 340 to transmit the simple and infrequent messages required by the present invention and one skilled in the art would certainly be able to adapt existing mobile phone technology to satisfy the communications and power requirements of the present invention without consuming undue space within a specimen lockbox 120.

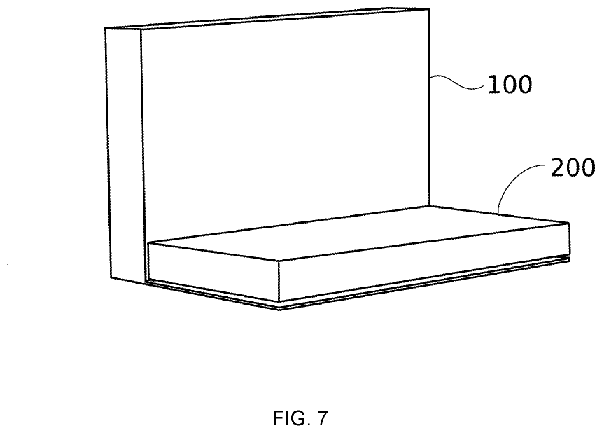

FIG. 7 shows an alternate configuration for an enclosure 100 with a pressure plate 200. In this example, the volume beneath the top surface of the pressure plate is reduced as the associated componentry has been located behind the pressure plate 200 (and behind a panel) rather than beneath the pressure plate.

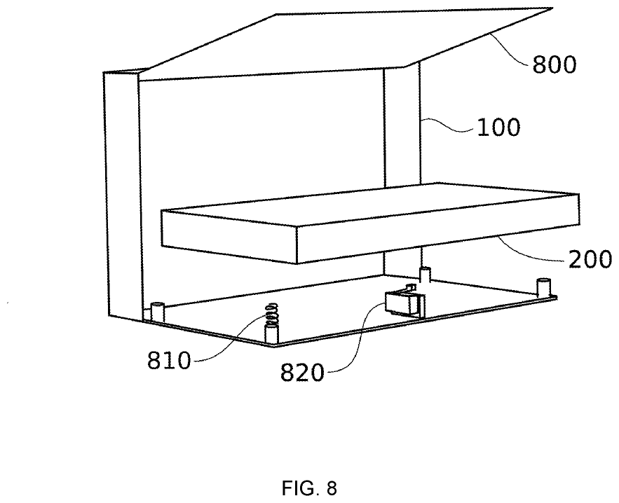

FIG. 8 provides additional detail on the example shown in FIG. 7. In FIG. 8, the panel/cover 800 has been pivoted up to reveal a space where the communications, processing and power components may be placed. The pressure plate 200 is shown above its functioning position to reveal a spring 810 and limit switch 820.

Hardware enclosures 100 may be customized in many ways by customers such as laboratories. A customer designed enclosure may display branding along with specimen bag placement directions.

### In Operation

The present invention should generate substantial cost savings to the laboratory industry that is currently under substantial cost challenges. There is presently no known product and/or technology solution directed specifically at monitoring the vacancy of laboratory specimen collection boxes. The courier industry and some large laboratories are using Courier Management System tracking software to monitor the activities of a courier and actual pickup, but the question of whether a specimen lockbox has any contents is uniquely addressed by the present inventive system.

In some embodiments, the present invention takes the form of an “all-in-one” custom container that will be placed inside the laboratory specimen collection box. As discussed, the enclosure 100 may be removably secured within laboratory specimen collection boxes, enabling its transfer from one box to another. Preferably, the enclosure would be fastened in place in such a way that prevents it from moving around during use. The enclosure 100 can be secured to the box 120 in a variety of ways. For example, screws can be used to fix the enclosure to the interior of the collection box 120. Alternatively, clips, magnets, velcro-style fasteners or suction cups may be employed. There may be unique benefits to securing the enclosure 100 with an adhesive. In particular, low tack adhesive 410 on at least one surface of the enclosure 100 (as shown in FIG. 4, securing the enclosure to the top interior surface of the lockbox) might enable it to be secured, while allowing the placement to be adjusted with few if any permanent modifications to the surface of the collection box 120.

In operation, the present invention will notify the internal or 3rd party courier that a package is in the container. The system is designed to detect and deliver an alert (notification) when a change occurs in the contents of the specimen collection box, i.e. is there a package in the box that requires a pickup. The system in operation eliminates the costly process of couriers checking boxes for packages when no packages are in the box.

A brief example of the use of the present system starts with a specimen 150 being deposited within a lockbox that is equipped according to the teachings of the present invention. Upon placing the specimen 150 within the lockbox 120, the weight of the specimen exceeds a threshold (corresponding to a weight-sensing embodiment) and triggers the activation of a communications module 330 within the inventive system. The communications module 330 can register the change in many ways—by some action (sending a signal suggesting there is a sample) or inaction (failing to send a signal suggesting there is no sample). In any case, the result of the receipt and interpretation of this signal is that a courier is scheduled to visit the specimen lockbox 120 and pick up the specimen 150. Because the courier is only scheduled when the specimen presence is indicated (rather than periodically), there is a reduction in the number of visits to empty specimen lockboxes and enhanced productivity via optimized pickup.

The system may communicate using any one of many communications mechanisms including, but not limited to, cellular networks or other IoT networks. Each individual “all-in-one” container may be identified in tracking software utilized by the customer. The software may contain the address of the location of the lab smartbox inside the specimen collection box, the method to be used to notify the courier (email, text, online report), the frequency (seconds, minutes, hours, days) of the technology to check the change in status of the contents/no contents. In turn, the software may document time in increments of minutes when the status of the box 120 changes so after a courier picks up the contents of the box, the software documents the status change. In addition, the software may allow for customization of courier routes and visual status (green or red) of each specimen collection box.

The integration of the signal being sent from the lockbox may also be made to an enhanced courier management software package, possibly via a call to an available application programming interface (API). Current courier management software uses GPS technology to track driver locations and time of stops or travel however there is no product that tells a courier whether a package is in the specimen collection box. A primary purpose of the present invention is to send a signal a courier when a package is in the box, thereby eliminating unnecessary costly stops.

Another example of a pickup service being used by laboratories and hospitals that should benefit from the proposed technology relates to on-demand pickup service level and routine transfers among large medical campuses. Currently, in the on-demand pickup service an employee of the medical practice will call the laboratory or schedule an on demand pickup online. These services can be time consuming and require multiple “touches.” The proposed technology can provide immediate notification when the contents of a medical specimen box changes which will eliminate the need for medical personnel to spend time scheduling pickups. Routine transfers of specimens among large medical campuses require personnel to check locations/bins for specimen transfer even when a bin is empty. The proposed technology will help large medical campuses utilize their human resources more efficiently.

The present invention inexpensively and conveniently provides a much needed first step of reporting that a specimen requires transportation. Thereafter, existing courier technology can be used to track the courier and package through traditional processes and mechanisms.

While certain preferred embodiments have been illustrated and described for purposes of the present disclosure, numerous substitutions in components may be made by those skilled in the art. It is to be understood that the present invention may be practiced otherwise than as specifically described herein without departing from the scope and spirit thereof.

I claim:

1. A laboratory specimen box system comprising:
a laboratory specimen box;
at least one sensor to detect the presence of a specimen; and
a communications module operable to communicate the presence of a specimen.

2. The laboratory specimen box system of claim 1, further comprising a low profile antenna.

3. The laboratory specimen box system of claim 1, wherein said communications module communicates over at least one cellular network.

4. The laboratory specimen box system of claim 1, further comprising a secondary sensor.

5. The laboratory specimen box system of claim 4, wherein detection of a specimen activates said secondary sensor.

6. The laboratory specimen box system of claim 4, wherein said secondary sensor is a GPS sensor.

7. The laboratory specimen box system of claim 4, wherein said secondary sensor is a thermometer.

8. The laboratory specimen box system of claim 1, wherein said laboratory specimen lock box is environmentally sealed.

9. The laboratory specimen box system of claim 1, wherein said laboratory specimen box is insulated.

10. The laboratory specimen box system of claim 9, wherein foam provides the insulation.

11. The laboratory specimen box system of claim 1, further comprising:
a housing to contain said sensor and communications module, wherein said housing is removably attached to said laboratory specimen box.

12. The laboratory specimen box system of claim 11, wherein said housing is contained within said laboratory specimen box.

13. The laboratory specimen box system of claim 11, wherein said housing is transferable between specimen boxes.

14. The laboratory specimen box system of claim 1, further comprising a solar panel operable to provide at least a portion of the energy required by the operation of said communications module.

15. A method for transporting a laboratory specimen, the method comprising:
receiving a signal from a laboratory specimen lockbox, wherein said signal implies the state of the laboratory specimen lockbox, wherein said state is selected from the group consisting of at least “empty” and one other state; and
creating a courier route such that at least one laboratory specimen lockbox with state “empty” is not scheduled.

16. The method for transporting a laboratory specimen lockbox of claim 15, the method comprising:
receiving secondary sensor information from said laboratory specimen lockbox; and
prioritizing at least one laboratory specimen lockbox based on said secondary sensor information.

17. A laboratory specimen lockbox content presence reporter comprising:
a primary sensor, operable to detect the presence of a package within a laboratory specimen lockbox;
a communications module, operable to send a signal upon detection of said package by said primary sensor; and
a power supply, operable to provide power to said communication module.

18. The laboratory specimen lockbox content presence reporter of claim 17, further comprising a secondary sensor, operable to detect at least one environmental condition.

19. The laboratory specimen lockbox content presence reporter of claim 18, wherein said secondary sensor is a thermometer.

20. The laboratory specimen lockbox content presence perporter of claim 18, wherein said secondary sensor is a GPS receiver.
